(19) United States
(12) Patent Application Publication
(10) Pub. No.: US 2006/0028555 A1
(43) Pub. Date: Feb. 9, 2006

(54) Method and system capturing images on a removable memory device

(75) Inventor: John R. Fredlund, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/902,312

(22) Filed: Jul. 29, 2004

(51) Int. Cl. H04N 5/232

(52) U.S. Cl. 348/211.4

(57) ABSTRACT

A method and system for capturing images on a removable memory device using a remote digital image capture device. Input stations are provided for receiving a removable memory device at a location proximal to an image capture location. The input stations each have a control device for controlling operation of remotely positioned digital image capture. A user places a removable memory device in the input station wherein a scene captured by the remote digital image capture device is recorded on the removable memory device. The user may control various operations of the remote image capture device.

### FIELD OF THE INVENTION

The present invention is directed to a system and method for consumer capture of high resolution images in an easy and convenient manner.

### BACKGROUND OF THE INVENTION

A consumer is required to carry a camera whether film or digital in order to capture images. The average photographer most frequently takes photographs during holidays, special events and on vacation. This typically requires the consumer to carry a camera on the chance a photographic opportunity may arise. However, in certain situations this can be an impediment to the event, vacation or other situation the consumer is in, in that the consumer is required to take care that the camera is not damaged, lost or stolen. One solution to the problem is the providing of relatively inexpensive cameras for use by the consumer. However, these low cost cameras often have a great disadvantage in that the quality of the images captured are of a relatively low quality. Another problem that often exists in capturing images, especially on vacations, is that the consumer is not able to take a picture from a point of view that would provide the most desirable image. The point of view may be from an area that is inaccessible, or too dangerous to access by the user

Recently, there has been the advent of the phone cam, i.e. a cellular phone having a camera therewith. However, the solution requires a relatively more expensive device. In addition, the quality of images captured is relatively low due to the relatively low resolution of the camera. In addition, these type of cameras are now being restricted from being carried into certain venues.

The present invention is directed to a method and system whereby the consumer can capture a variety of images in a relatively convenient and easy manner.

### SUMMARY OF THE INVENTION

In accordance with one aspect of the present invention there is provided a method for capturing images on a removable memory device using a remote digital image capture device, comprising the steps of:
providing an input station for receiving a removable memory device at a location proximal to an image capture location, said input station having a control device for controlling operation of a user non-accessible remotely positioned digital image capture device by a user at said input station for capturing an image of a scene at said image capture location;
said user placing a removable memory device in said input station;
said user controlling operation of said digital image capture device so as to cause an image of said scene to be captured by said digital image capture device and forwarded to input station for recording on said removable memory device; and
said user removing said memory device from said input station.

In accordance with another aspect of the present invention there is provided a system for capturing images on a removable memory device using a remote digital image capture device, comprising the steps of:
a digital image capture device positioned remotely with respect to an image capture location for capturing a digital image of a scene at said image capture location; and
an input station for receiving a removable memory device at a location proximal to an image capture location, said input station having a control device for controlling operation of said remotely positioned digital image capture device by a user at said input station for capturing said image of a scene at said image capture location, said user controlling operation of said digital image capture device so as to cause an image of said scene to be captured by said digital image capture device and forwarded to input station over a communication network, and a recording mechanism for recording said digital image received from said digital image capture device on said removable memory device.

In accordance with still another aspect of the present invention there is provided a system for capturing images on a removable memory device using a remote digital image capture device, comprising the steps of:
a digital image capture device positioned remotely with respect to a image capture location for capturing a digital image of a scene at said image capture location; and
an input station for receiving a removable memory device at a location proximal to an image capture location and a recording mechanism for recording said digital image received from said digital image capture device on said removable memory device; and
a user provided input device for controlling operation of said remotely positioned digital image capture device by a user at said input station for capturing said image of a scene at said image capture location, said user provided input device controlling operation of said digital image capture device so as to cause an image of said scene to be captured by said digital image capture device and forwarded to input station over a communication network.

In accordance with yet another aspect of the present invention there is provided a method for capturing information on a removable memory device comprising the steps of:
providing a plurality of input stations for receiving a removable memory device at locations proximal to an area of interest, said locations being related to one another;
said user placing a removable memory device in at least one input station;
said at least one input station writing information to said removable memory device; and
said user removing said memory device from said at least one input station.

In accordance with another aspect of the present invention there is provided a method for capturing images on a removable memory device using a remote digital image capture device, comprising the steps of:
providing a plurality of input stations each having a detection device for detecting when a designated memory device is located proximal to one of said plurality of detections stations, said input device having an alerting device for alerting the holder of said designated memory device that it is proximate to said input station; and
said input station controlling operation of said digital image capture device so as to cause an image of said scene to be captured by said digital image capture device and forwarded to said memory device.

In accordance with still another aspect of the present invention there is provided a method for capturing images on a removable memory device using a remote digital image capture device, comprising the steps of:
providing an RF transceiver for receiving a removable memory device at a location proximal to an image capture location, the RF transceiver capable of receiving an image of a scene at the image capture location;
placing a removable memory device in the RF transceiver;
the RF transceiver controlling operation of the digital image capture device so as to cause an image of the scene to be captured by the digital image capture device and forwarded to the RF transceiver for recording on the removable memory device; and
removing the memory device from the RF transceiver.

These and other aspects, objects, features and advantages of the present invention will be more clearly understood and appreciated from a review of the following detailed description of the preferred embodiments and appended claims and by reference to the accompanying drawings.

### BRIEF DESCRIPTION OF THE DRAWINGS

In the detailed description of the preferred embodiments of the invention presented below, reference is made to the accompanying drawings in which:

FIG. 1 is a schematic view of a system made in accordance with the present invention;

FIG. 2 is an enlarged view of the input station of the system of FIG. 1;

FIG. 3 is a schematic view of a building on which a camera for use in the system of FIG. 1 is positioned;

FIG. 4 is side view of the building of FIG. 3 illustrating several different input stations in relationship to a camera in the building for using in the present invention;

FIG. 5 is schematic of a system made in accordance with the present invention wherein there is provided a plurality of remote camera and associated input stations;

FIG. 6 is a view similar to FIG. 2 illustrating a modified input station made in accordance with the present invention;

FIG. 7 is a schematic view of a building having a camera for use in the system and an associated sign for providing information for accessing and controlling camera for use;

FIG. 8 is a flow diagram illustrating use of the system made in accordance with the present invention;

FIG. 9 is an enlarged view of a wireless phone for use in the system in accordance with the present invention; and

FIGS. 10A & 10B illustrate a wireless device to use in the system of the present invention illustrating various steps in the process of capturing an image.

### DETAILED DESCRIPTION OF THE INVENTION

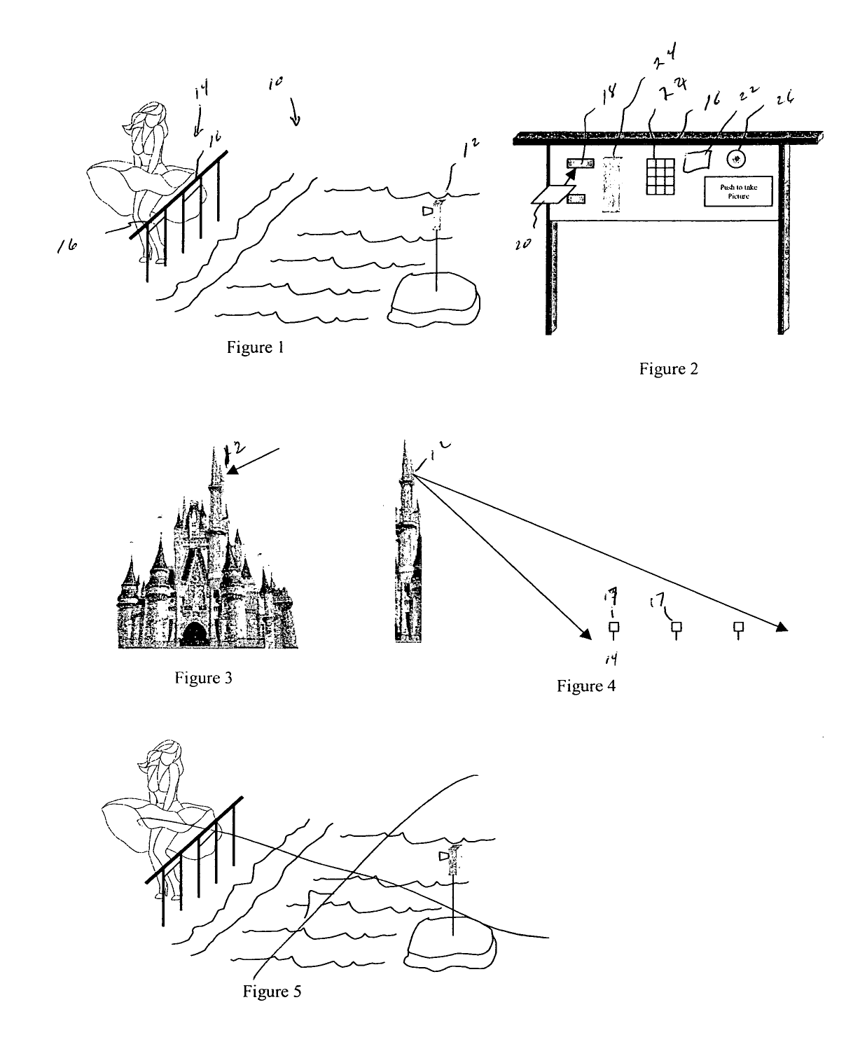

Referring to FIGS. 1-4, there is illustrated a venue for practicing the system and method of the present invention. In particular, the venue illustrated in FIG. 1 illustrates a location in a theme park in which a plurality of different digital stationary positioned cameras are provided for capturing images of scenes and patrons. In the scene illustrated in FIG. 1, there is provided a camera 12 for capturing an image of a scene/location 14. At least one input station 16 is provided at or adjacent scene 14. In the particular embodiment illustrated, two input stations 16 are provided. Each of the input stations has various control devices. In the particular embodiment illustrated, input station has a receiving slot 18 for receiving a removable memory device 20. In the particular embodiment illustrated, the memory device is an SD or MMC card or other appropriate device that may be used such as those found in digital cameras. It is to be understood that any appropriate number of slots 18 may be provided for receiving any type of portable memory card or device. Today these type memory cards/devices, i.e. for example flash memory card (used in digital cameras), can hold hundreds of digital images even at relatively high resolution. For example, there are flash memory cards available today that can hold several hundreds of images compressed from four mega pixel resolution. In the particular embodiment illustrated, each input station 16 is provided a display screen 22 and a payment mechanism 24 designed to receive credit cards and/or cash for payment. The display screen 22 may be used for providing instructions to the user and/or providing displays of images that have been captured by camera 12. Display screen 22 can also be used for previewing what the camera 12 will capture. Display screen 22 may be best positioned remotely from station 16 and out of the capture area of camera 12 in an area that is advantageous for preview and review of captured pictures. In the particular embodiment illustrated, control pad 26 is provided for activating and controlling remote camera 12. Capture button 28 may be provided separately from control pad 26.

In the embodiment illustrated, the memory card 20 to be used with input station 16 may be a memory card supplied by the theme park and/or may be a personal memory card that is owned by the user. If the memory card 20 is owned by the theme park (or owner of the venue) an electronic and/or physical ID may be placed on the memory card 20. This ID may be read by the input station 16 when the card is placed in receiving slot 18. In this way there may be no need for providing payment mechanism 24 on the input station 16 thereby reducing the cost of the input station 16. Likewise, the input control 24 and input screen 22 may be omitted in order to further reduce the cost of the input station 16. In this mode there would be no choice by the user except capture of an image of the designated location/scene. Appropriate signs may be provided to indicate the scene to be captured. Also the display screen can be used by the user to know where to position the user and/or accompanying friends so that they can be captured or not captured in the picture to be taken. It is of course understood that any other appropriate sections can be made, for example, but not limited to selection of the size of the image, number of images to be captured, the time of the image capture and lighting characteristics of the image to be captured. An optional alarm, audio and/or visual, may be provided to remind the user to remove the memory card upon completion of the desired transaction or provide confirmation that the image has been captured. Input station 16 may be minimized to include only a receiving slot 18 for memory device 20. In this configuration, the insertion of memory device 20 can begin the capture sequence. A delay from insertion to capture is provided. The control device provided is limited to receiving slot 18 that detects insertion of memory device 20 and controls camera 12.

System 10 may be limited to a single camera 12 and a single input station 16. This configuration provides images to memory device 20 without the need for networking or computer interfaces.

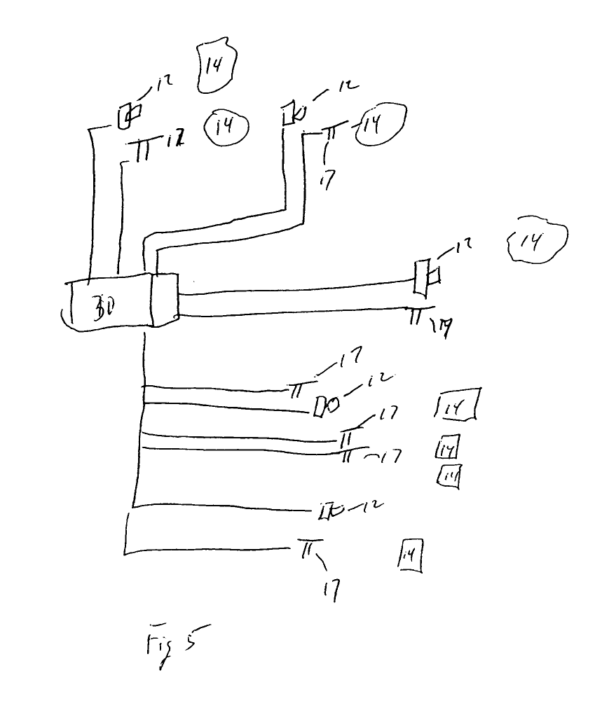

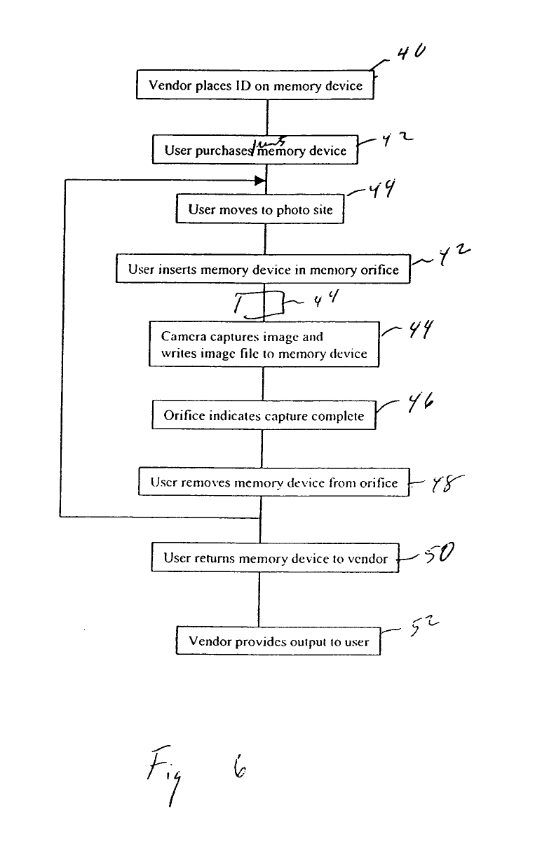

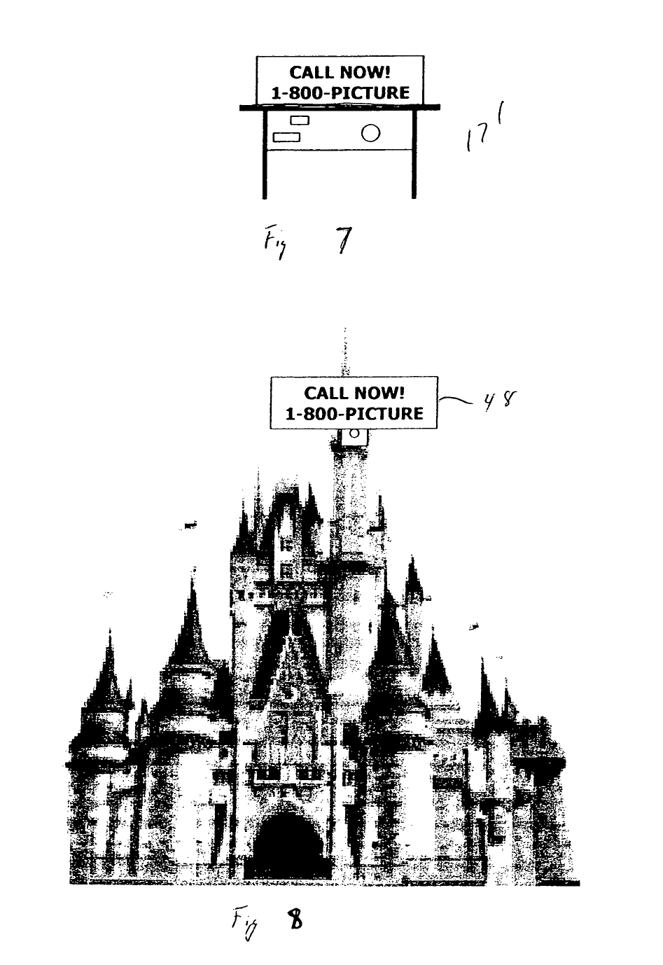

There may be provided a plurality of input stations 16 each connected to a central computer 30 as illustrated in FIG. 5. As can be seen by FIG. 5, the central computer 30 can be connected to a plurality of different cameras and input stations 15 for capturing various scenes 14. As illustrated by FIG. 1, there may be two different input stations at the same one scene in which case, the computer 30 will be able to discriminate between which of the input stations being used and which particular portion of the scene is to be captured. Alternatively, when camera 12 is of high resolution, only a portion of the captured image pertinent to a particular input station 16 may be delivered to that particular input station 16. The control pad can also be used to adjust camera 12 so that it can capture portions of a scene or various different scenes within the capability of the movement of the camera and other camera controls. Also, input stations 16 can be networked to provide billing.

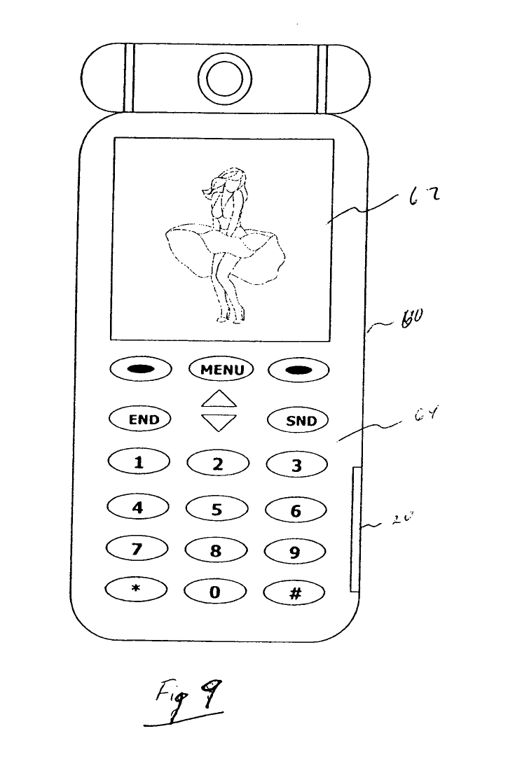

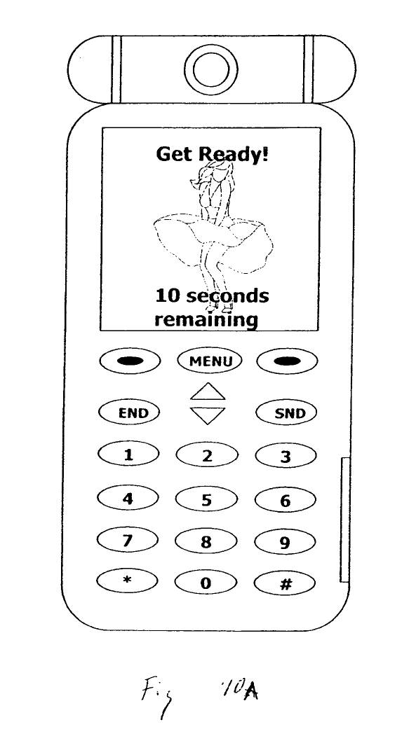

Referring to FIG. 6 there is illustrated a flow diagram for practicing one aspect of the present invention. In this embodiment, the first step 40 resides in a vender providing an ID on a memory device 20, preferably in an electronic readable form on memory device 20 which is provided by the theme park. Alternatively, the ID can be placed on a user provided memory device 20. At step 42, the user either purchases or rents the memory device 20. Prepayment information may also be placed on the card such that the user need not do anything other than carry around the memory card/device 20 and placing it into the appropriate input stations 17 for capturing of the digital images digitally on the memory card 20. Alternatively, an ID for the purpose of billing may be placed on a customer provided memory card wherein this information again will be transmitted from the input station 17 to the computer as appropriate. At the next step 44, the user moves to a photosite 14 at step 44. The user at step 46 places the memory device into the slot 18. At step 44 the consumer enters any appropriate instructions to be provided and may even control the camera for providing enlargements or cropping of the scene as displayed by display device 22. Once having determined the desired image is to be captured, the camera at step 44 captures the image and writes it onto the digital memory device. The input station 17 at step 46 provides an indication either audible or visual that the image has been written onto the memory device 20. At the next step 48, the user removes the memory card 20 from the slot 18. The user can repeat the process at a different input station 17. An optional password may be associated with the removable memory card 20 to prevent misuse of the card by an unauthorized individual. The ID can be used for a variety of other functions, for example, the identification of a user account to be debited, to indicate the location of the site of an authorized camera, to indicate the date or time of image capture or authorization for image capture.

The ID may correspond to different levels of authorization. For example, one level of approval may allow access to all input stations 16 or images from cameras 12 in the park. Another level may provide access only to particular input stations 16 or images from particular cameras 12. One level of authorization can provide full resolution images while another can provide limited resolution. In these manners different levels of service can be offered.

In the particular embodiment illustrated, the user returns the memory of a device 20 to the vendor wherein, in one option the vendor will provide the appropriate output to the user as desired and selected by the consumer, for example hard copy prints. Alternatively, if the user has purchased the memory card or has provided his own, the user simply takes the memory card 20 and provides it to any service provider deemed appropriate for ordering of appropriate image products. The user may of course use the memory device 20 on his or her own computer or other devices.

Referring to FIG. 7, there is illustrated a modified input station 17′. In this particular embodiment, the input station 17′ has many of the same items as input station 17 like numerals indicating like parts and operation. However, in this embodiment, there is provided a visible sign 48 associated with input station 17′ indicating that a certain phone number used to access and provide for storing of image data on the memory card at input station 17′. In this embodiment, a customer supplied memory card is provided in slot 18. If the user has a wireless phone 52, the consumer can call the designated number and control operation of the associated remote camera 50 using the wireless phone/device. This allows for providing a simple input station 17′. The image data may be sent to input station by hard wire connection, or optional broadband wireless communication. There is no need for the input station to be directly connected to the computer and thus the input station may be a stand alone which simply writes image data onto memory card 20 provided by the user. FIG. 7 illustrates sign 48 placed adjacent the camera 50 so that the user will know from which angle the image will be captured. The display screen on the wireless phone 52 may be used to view the image to be captured by the remote camera 50 which again provides a phone number whereby access to the camera 50 is provided by dialing in of that phone number. Again, the camera 50 would be controlled by the cell phone and providing output directly to the input station 17.

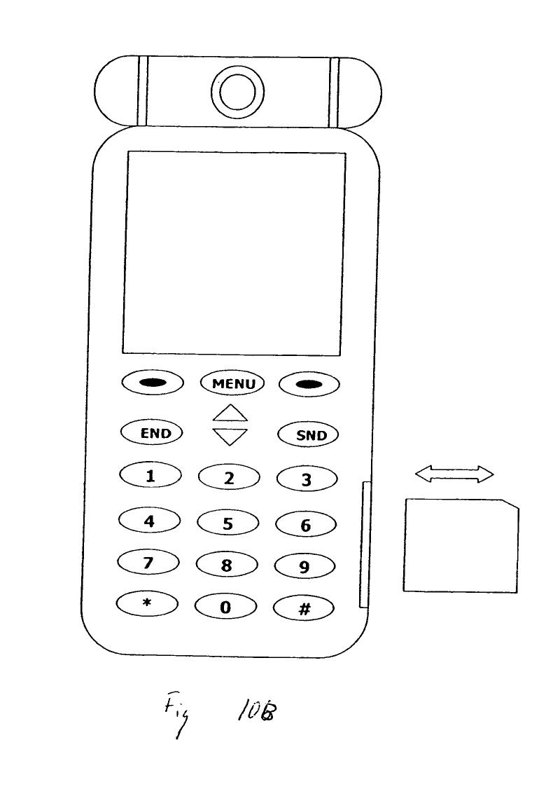

Referring to FIGS. 9, there is illustrated a wireless device for use in the present invention. In the embodiment illustrated, the device 60 is a cell phone. However, the cell phone may be any other appropriate wireless device such as a PDA (personal digital assistant) or any other device that is capable of providing communication. The device 60 includes a slot for receiving a memory card 20. In this embodiment, the device 60 has a display screen 62 for displaying images that are in real time being captured by the remote camera. The selection panel may be used for controlling of the camera in deciding when to capture an image. As illustrated in FIG. 10A, there can be provided information as to how much time is remaining until the image is captured. This allows the user to put away the device and get into the scene properly. FIG. 10B illustrates the memory card being placed into or being removed from the device. Once the image has been captured, the digital images can be transmitted back to the device 60 for writing on the memory card. If the wireless device 60 has broad band communication, e.g., Bluetooth or WiFi, then the image data can relayed to the device in a quick and efficient manner.

In the practice of the present invention the consumer need not carry around a special camera that can be lost. The user need only carry a memory card that can be placed in a variety of different input stations that are directly connected to the remote digital cameras. It is of course understood that the connections between the various components may be hardwired between the digital camera. The input station and computer may be hardwired or wireless as appropriate. All that is needed is appropriate connections for transmitting of the data to the input station for recording of the information on the memory card in a quick and efficient manner. If wireless connections are used, preferably broadband communication such as Bluetooth or WiFi or others may be employed for transmissions of large amounts of data.

The remote digital camera 12 is preferably of a high resolution camera of 3 mega pixels or greater for image. Obviously the higher the mega pixel capability of the digital camera, the fewer number of pictures that may be available for placement on the memory card 20. However, as previously noted, memory cards 20 are such that a multitude of images may be captured thereon.

The input stations in addition to recording images thereon, may also be used to edit images, i.e., the deletion of unacceptable images from the memory card or providing various other editing functions like image enhancement such as color enhancement and/or cropping. Any desired image manipulation may be provided as capable of the input station and/or device 60. In addition the input station may be used to add or request the addition of text, video, audio to be associated with image capture (or to be captured). The input station may also be provided with on/off controls to control the automatic capturing of images. There may also be optional networking of the captured images to a personal computer over a network, for example the internet, for later selection or review by the customer and/or sharing with a third party.

In another form of the present invention, the input station may include detection sensor such as an RF tag for detecting when a memory device in the area is closely related to the input station. An audible and/or visible alarm may be provided by the input station when a designated memory device is in the vicinity. The alarm will alert the user of the presence of the input station for use by the user as previously described. In this embodiment there need not be a slot for receiving the memory, as the memory device may simply be a wireless memory receiving device for receiving images associated with the input station. In this case memory device 20 is provided with an RF transceiver. The user may have a control for accepting or not accepting images in response to the notice by the input station. The user may simply walk around wherein images are automatically transferred directly to the memory device carried by the user. An example of such a memory device is a wireless phone, a PDA (personal digital assistant) having wireless communication or a removable memory card, or simply a memory card having a transponder. This transponder or the memory device 20 may have a unique recognizable ID. The holder of the designated device can use the input station for order of images to be captured and transferred to the device, or removable memory card, either by wireless transmission or by placing the memory in communication link with the input station. If wireless transmission is used, communication may be direct with the remote camera or intermediate server or other communication device. The user can carry the transceiver connected to memory device 20 and have a collection of images automatically written on the memory device when he is finished carrying the transceiver and memory device 20.

It is to be understood that various other changes and modifications may be made without departing from the scope of the present invention. The present invention being limited by the following claims.

The invention has been described in detail with particular reference to certain preferred embodiments thereof, but it will be understood that variations and modifications can be effected within the spirit and scope of the invention.

### PARTS LIST

10 system
12 camera
14 scene/location
16 input station
17 input station
18 receiving slot
20 memory device
22 display screen
24 payment mechanism
26 control pad
28 capture button
30 central computer
40 step
42 step
44 step
46 step
48 step
50 remote camera
52 wireless phone
60 device
62 display screen

1. A method for capturing images on a removable memory device using a remote digital image capture device, comprising the steps of:
providing an input station for receiving a removable memory device at a location proximal to an image capture location, said input station having a control device for controlling operation of a user non-accessible remotely positioned digital image capture device by a user at said input station for capturing an image of a scene at said image capture location;
said user placing a removable memory device in said input station;
said user controlling operation of said digital image capture device so as to cause an image of said scene to be captured by said digital image capture device and forwarded to input station for recording on said removable memory device; and
said user removing said memory device from said input station.

2. A method according to claim 1 wherein the control device is limited to a detector for detecting the insertion of the removable memory device.

3. A method according to claim 1 further comprising the step of:
providing an alarm advising said user that said removable memory device has been written to or is to be removed.

4. A method according to claim 1 further comprising the step of:
providing an alarm advising said user that a designated time period for capturing of an image is about to expire.

5. A method according to claim 1 further comprising the step of:
providing an indication by said input station that writing of said image to said removable memory device is complete.

6. A method according to claim 1 wherein said user is able to control one or more parameters of the image composition of said scene to be captured by said digital image capture device.

7. A method according to claim 6 wherein said one or more parameters is selected from the following:
selection of the size or location of scene;
number of images to be captured;
the timing of image or images to be captured;
lighting characteristics of the digital image capture device;

8. A method according to claim 1 further comprises the step of:
reading said removable memory device to locate an ID on said removable memory device.

9. A method according to claim 8 wherein said ID provides authorization for using of said input station.

10. A method according to claim 9 further comprising the step of:
requiring a password by said user prior to granting authorization to said user.

11. A method according to claim 8 wherein said ID is used to debit an account of said user.

12. A method according to claim 9 further comprising levels of authorization.

13. A method according to claim 1 wherein said ID is an indication of the location of the site of the camera or scene.

14. A method according to claim 1 wherein said ID is an indication of the time or date of capture.

15. A method according to claim 1 wherein said operation controlled is image capture.

16. A method according to claim 1 wherein additional information is recorded in association with one of said captured images.

17. A method according to claim 16 wherein said additional information comprises any one of the following:
text,
video,
audio,
prerecorded image.

18. A method according to claim 1 wherein said input station includes a display.

19. A method according to claim 1 wherein a display is provided remote from said input station.

20. A system for capturing images on a removable memory device using a remote digital image capture device, comprising the steps of:
a digital image capture device positioned remotely with respect to an image capture location for capturing a digital image of a scene at said image capture location; and
an input station for receiving a removable memory device at a location proximal to an image capture location, said input station having a control device for controlling operation of said remotely positioned digital image capture device by a user at said input station for capturing said image of a scene at said image capture location, said user controlling operation of said digital image capture device so a cause an image of said scene to be captured by said digital image capture device and forwarded to input station over a communication network, and a recording mechanism for recording said digital image received from said digital image capture device on said removable memory device.

21. A system according to claim 20 wherein said input station is capable of receiving a plurality of said removable memory devices.

22. A system according to claim 20 wherein said recording mechanism can also record audio on said removable memory device.

23. A system according to claim 20 wherein said input station further comprises a payment mechanism for accepting payment by said user.

24. A system according to claim 20 wherein said input station further comprises a mechanism for providing an alarm advising said user that said removable memory device is to be removed.

25. A system according to claim 20 wherein said input station further comprises a mechanism for providing an alarm advising said user that a designated time period for capturing of an image is about to expire.

26. A system according to claim 20 wherein said input station further comprises a mechanism for providing an alarm advising said user that capturing of said image is complete.

27. A system according to claim 20 wherein said input station further comprises a mechanism for allowing said user is control one or more parameters of the image of said scene to be captured by said digital image capture device.

28. A system according to claim 27 wherein said one or more parameters comprises one or more of the following:
selection of the size or location of scene;
number of images to be captured;
the timing of image or images to be captured;
lighting characteristics of the digital image capture device;

29. A system according to claim 20 wherein said input station further comprises a mechanism for reading said removable memory device so as to locate an ID on said removable memory device.

30. A system according to claim 29 wherein said ID provides authorization for using of said input station.

31. A system according to claim 30 wherein a password by said user is also required prior to granting authorization to said user.

32. A system according to claim 29 wherein said ID is used to debit an account of said user.

33. A system according to claim 20 wherein communication network comprises a wireless connection.

34. A method according to claim 20 wherein said ID is an indication of the location of the site of the camera or scene.

35. A method according to claim 20 wherein said ID is an indication of the time or date of capture.

36. A method according to claim 20 wherein said operation controlled is image capture.

37. A system for capturing images on a removable memory device using a remote digital image capture device, comprising the steps of:
a digital image capture device positioned remotely with respect to a image capture location for capturing a digital image of a scene at said image capture location; and
an input station for receiving a removable memory device at a location proximal to an image capture location and a recording mechanism for recording said digital image received from said digital image capture device on said removable memory device; and
a user provided input device for controlling operation of said remotely positioned digital image capture device by a user at said input station for capturing said image of a scene at said image capture location, said user provided input device controlling operation of said digital image capture device so a cause an image of said scene to be captured by said digital image capture device and forwarded to input station over a communication network.

38. A system according to claim 37 wherein said user provided input device comprises a cell phone.

39. A system according to claim 38 wherein said cell phone comprises a display screen for allowing view of a captured image prior to recording on said removable memory device.

40. A system according to claim 37 wherein said user provided input device comprises a phone cam.

41. A system according to claim 40 wherein said phone cam comprises a display screen for allowing view of a captured image prior to recording on said removable memory device.

42. A system according to claim 37 wherein said input station is capable of receiving a plurality of said removable memory devices.

43. A system according to claim 37 wherein said recording mechanism can also record audio on said removable memory device.

44. A system according to claim 37 wherein said input station further comprises a payment mechanism for accepting payment by said user.

45. A system according to claim 37 wherein said input station further comprises a mechanism for providing an alarm advising said user that said removable memory device is to be removed.

46. A system according to claim 45 wherein said input station further comprises a mechanism for providing an alarm advising said user that a designated time period for capturing of an image is about to expire.

47. A system according to claim 37 wherein said input station further comprises a mechanism for providing an alarm advising said user that capturing of said image is complete.

48. A system according to claim 37 wherein said input device is used to control one or more parameters of the image of said scene to be captured by said digital image capture device.

49. A system according to claim 48 wherein said one or more parameters comprises one or more of the following:
selection of the size or location of scene;
number of images to be captured;
the timing of image or images to be captured;
lighting characteristics of the digital image capture device;

50. A system according to claim 37 wherein said input station further comprises a mechanism for reading said removable memory device so as to locate an ID on said removable memory device.

51. A system according to claim 50 wherein said ID provides authorization for using of said input station.

52. A system according to claim 51 wherein a password by said user is also required prior to granting authorization to said user.

53. A system according to claim 50 wherein said ID is used to debit an account of said user.

54. A system according to claim 37 wherein user input device is used for billing of said user for use of said digital capture device and input station.

55. A method for capturing information on a removable memory device comprising the steps of:
providing a plurality of input stations for receiving a removable memory device at locations proximal to an area of interest, said locations being related to one another;
said user placing a removable memory device in at least one input station;
said at least one input station writing information to said removable memory device; and
said user removing said memory device from said at least one input station.

56. A method according to claim 55 wherein said input stations can control said digital image capture devices so as to locate an object in said scene or focus of said scene.

57. A method according to claim 55 wherein confirmation indication of image capture is provided at said input stations.

58. A method for capturing images on a removable memory device using a remote digital image capture device, comprising the steps of:
providing a plurality of input stations each having a detection device for detecting when a designated memory device is located proximal to one of said plurality of detection stations, said input device having an alerting device for alerting the holder of said designated memory device that it is proximate to said input station; and
said input station controlling operation of said digital image capture device so as to cause an image of said scene to be captured by said digital image capture device and forwarded to said memory device.

59. A method according to claim 57 wherein confirmation indication of image capture is provided at said detection stations.

60. A method according to claim 57 wherein said captured image is transferred by placing said designated memory in communication link with said input station.

61. A method according to claim 60 wherein said communication link is wireless transmission.

62. A method according to claim 57 wherein said memory device comprises a wireless phone.

63. A method for capturing images on a removable memory device using a remote digital image capture device, comprising the steps of:
providing an RF transceiver for receiving a removable memory device at a location proximal to an image capture location, said RF transceiver capable of receiving an image of a scene at said image capture location;
placing a removable memory device in said RF transceiver;
said RF transceiver controlling operation of said digital image capture device so as to cause an image of said scene to be captured by said digital image capture device and forwarded to said RF transceiver for recording on said removable memory device; and
removing said memory device from said RF transceiver.
